(19) United States
(12) Patent Application Publication
(10) Pub. No.: US 2015/0281847 A1
(43) Pub. Date: Oct. 1, 2015

(54) APPARATUS AND METHOD OF PROVIDING AN ACOUSTIC SIGNAL

(71) Applicant: Nokia Technologies Oy, Espoo (FI)

(72) Inventors: Juha BACKMAN, Espoo (FI); Leo KARKKAINEN, Helsinki (FI)

(21) Appl. No.: 14/666,070

(22) Filed: Mar. 23, 2015

(30) Foreign Application Priority Data
Mar. 27, 2014 (GB) 1405464.7

(51) Int. Cl. H04R 7/14; H04R 19/02

(52) U.S. Cl. CPC H04R 7/14; H04R 19/02

(57) ABSTRACT

An apparatus and method wherein the apparatus comprises: a diaphragm wherein the diaphragm is configured into a corrugated arrangement comprising a plurality of folds; a plurality of bias electrodes where the bias electrodes are provided between folds of the diaphragm; and an input configured to provide at least one control signal to the diaphragm to cause movement of the diaphragm to generate an acoustic signal; wherein the diaphragm is configured such that bending stiffness of the diaphragm provides a restoring force to the diaphragm which causes the diaphragm to return to a neutral position when no control signal is applied.

### TECHNOLOGICAL FIELD

Examples of the present disclosure relate to an apparatus and method of providing an acoustic output signal. In particular, they relate to an apparatus and method of providing an acoustic signal comprising an electrostatic loudspeaker.

### BACKGROUND

Apparatus, such as loudspeakers, which enable an electrical input signal to be converted to an acoustic signal are known.

Electrostatic loudspeakers comprise a diaphragm positioned between a positive electrode and a negative electrode. When a voltage is applied to the diaphragm this causes the diaphragm to move between the electrodes and enables an acoustic signal to be produced.

It is useful to provide a loudspeaker, such as an electrostatic loudspeaker, which is suitable for use in a compact device.

### BRIEF SUMMARY

According to various, but not necessarily all, examples of the disclosure there may be provided an apparatus comprising: a diaphragm wherein the diaphragm is configured into a corrugated arrangement comprising a plurality of folds; a plurality of bias electrodes where the bias electrodes are provided between folds of the diaphragm; and an input configured to provide at least one control signal to the diaphragm to cause movement of the diaphragm to generate an acoustic signal; wherein the diaphragm is configured such that bending stiffness of the diaphragm provides a restoring force to the diaphragm which causes the diaphragm to return to a neutral position when no control signal is applied.

In some examples at least one bias electrode may be provided between every fold.

In some examples the bias electrodes may be provided alternately at positive and negative potentials.

In some examples folded portions of the diaphragm may be fixed in position.

In some examples the bias electrodes may provide an electric field and are arranged so that the electric field is small at the folded portions of the diaphragm.

In some examples the apparatus may be configured so that no external tensile forces are applied to the diaphragm to return the diaphragm to a neutral position.

In some examples a support structure may be configured to support the diaphragm. The support structure may be configured to provide the control signal to the diaphragm.

In some examples the diaphragm may have different thicknesses at different points.

In some examples the diaphragm may be arranged in a curved configuration.

In some examples there may be provided an electronic device as described above.

According to various, but not necessarily all, examples of the disclosure there may be provided a method comprising: providing a diaphragm wherein the diaphragm is configured into a corrugated arrangement comprising a plurality of folds; providing a plurality of bias electrodes where the bias electrodes are provided between folds of the diaphragm; and providing an input configured to provide at least one control signal to the diaphragm to cause movement of the diaphragm to generate an acoustic signal; wherein the diaphragm is configured such that bending stiffness of the diaphragm provides a restoring force to the diaphragm which causes the diaphragm to return to a neutral position when no control signal is applied.

In some examples the method may comprise providing at least one bias electrode between every fold.

In some examples the method may comprise providing the bias electrodes alternately at positive and negative potentials.

In some examples the method may comprise fixing folded portions of the diaphragm in position.

In some examples the bias electrodes may provide an electric field and are arranged so that the electric field is small at the folded portions of the diaphragm.

In some examples no external tensile forces may be applied to the diaphragm to return the diaphragm to a neutral position.

In some examples the method may comprise providing a support structure configured to support the diaphragm. The support structure may be configured to provide the control signal to the diaphragm.

In some examples the diaphragm may have different thicknesses at different points.

In some examples the diaphragm may be arranged in a curved configuration.

According to various, but not necessarily all, examples of the disclosure there may be provided examples as claimed in the appended claims.

The apparatus may be for providing an audio output signal.

### BRIEF DESCRIPTION

For a better understanding of various examples that are useful for understanding the brief description, reference will now be made by way of example only to the accompanying drawings in which:

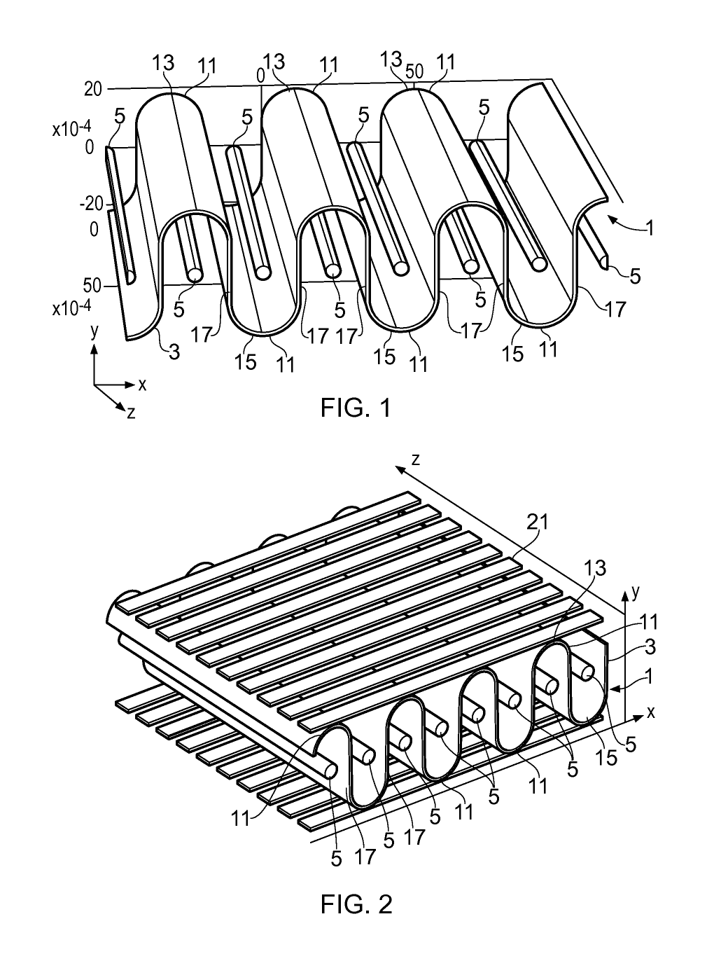

FIG. 1 illustrates an apparatus;

FIG. 2 illustrates an apparatus;

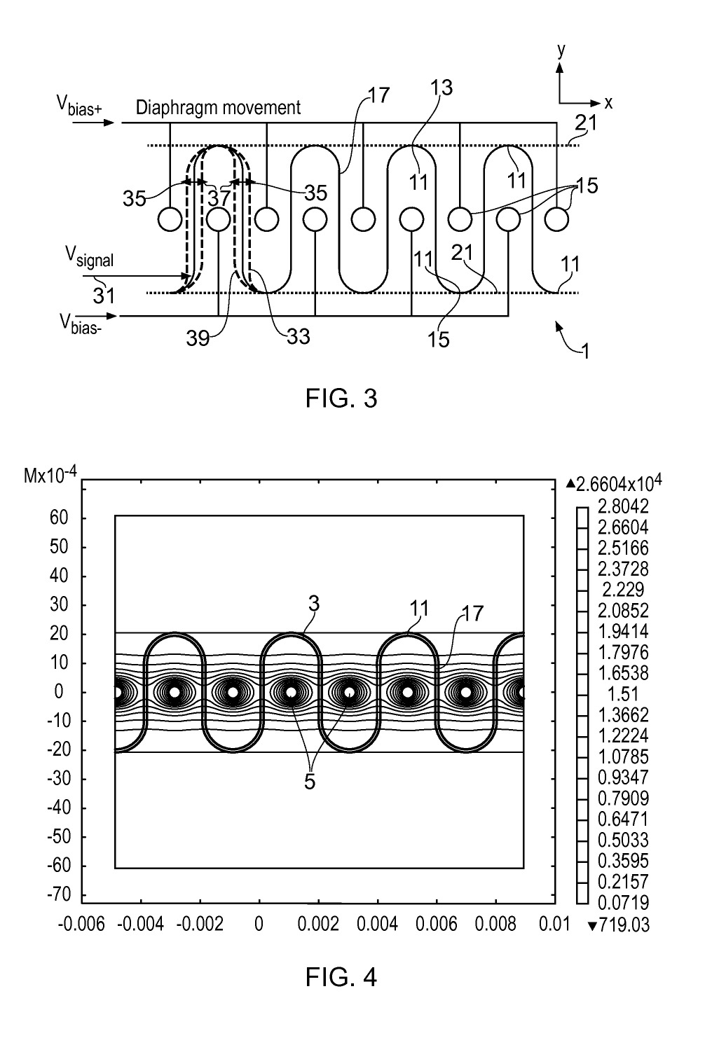

FIG. 3 illustrates a cross section of an apparatus;

FIG. 4 illustrates a plot of electric field strength;

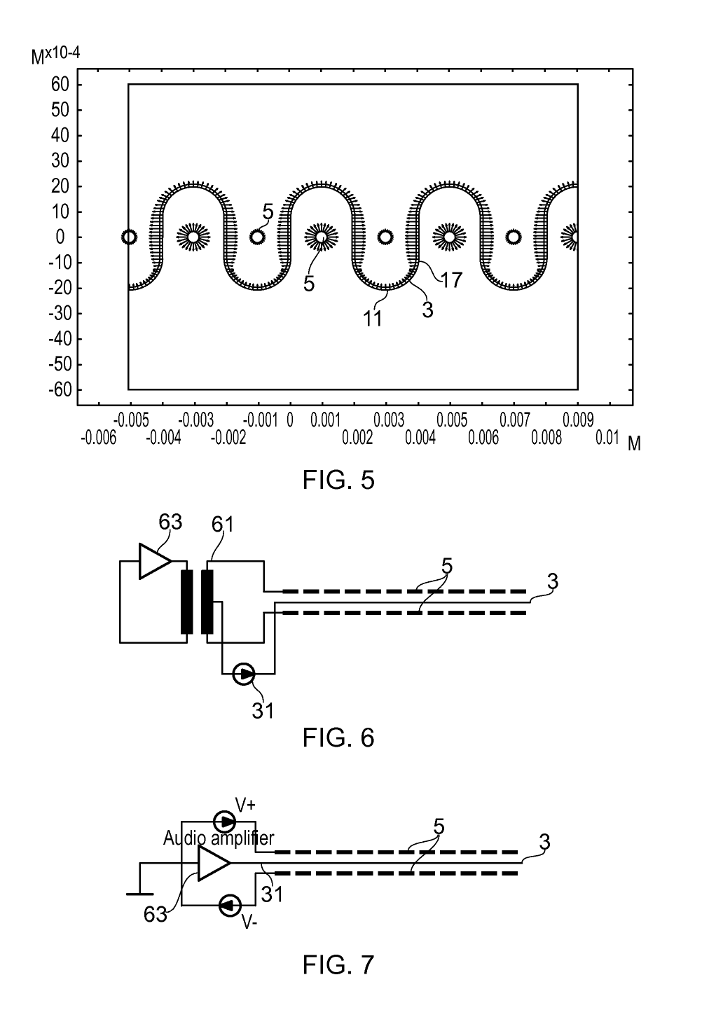

FIG. 5 illustrates a plot indicating the direction of the electric field;

FIG. 6 illustrates an example electric circuit for an apparatus;

FIG. 7 illustrates another example electric circuit for an apparatus;

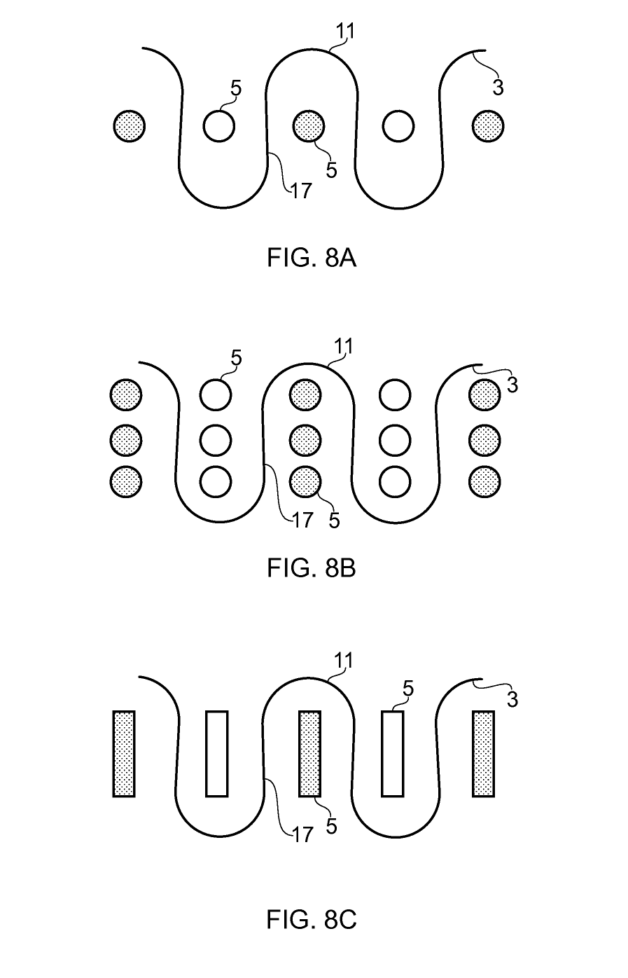

FIGS. 8A to 8C illustrate cross sections through example apparatus;

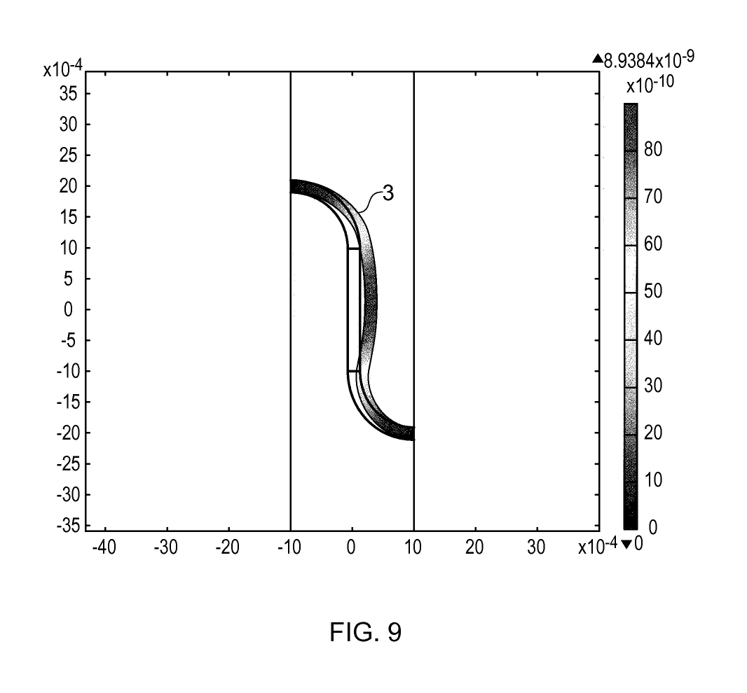

FIG. 9 illustrates an example displacement of a diaphragm in an apparatus;

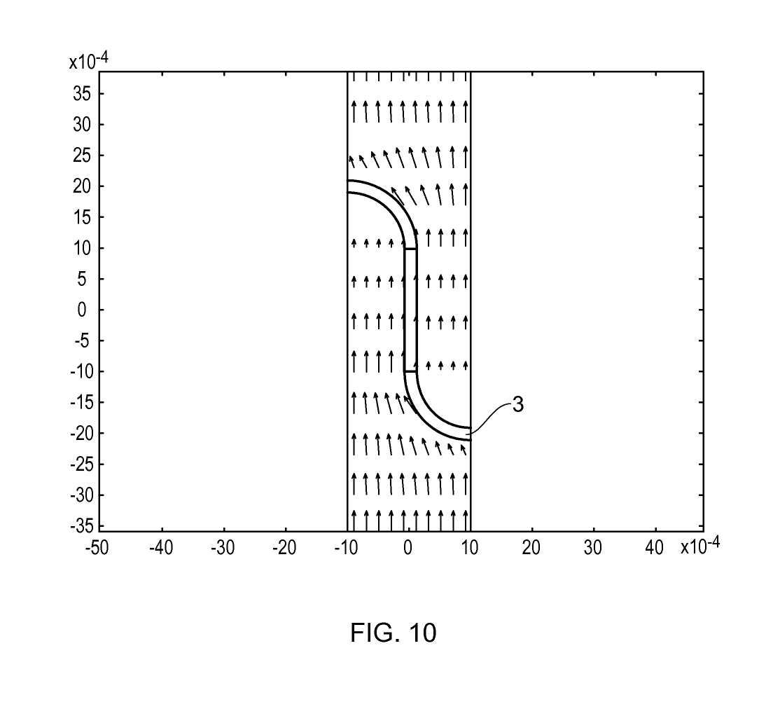

FIG. 10 is a plot of air velocity in an apparatus; and

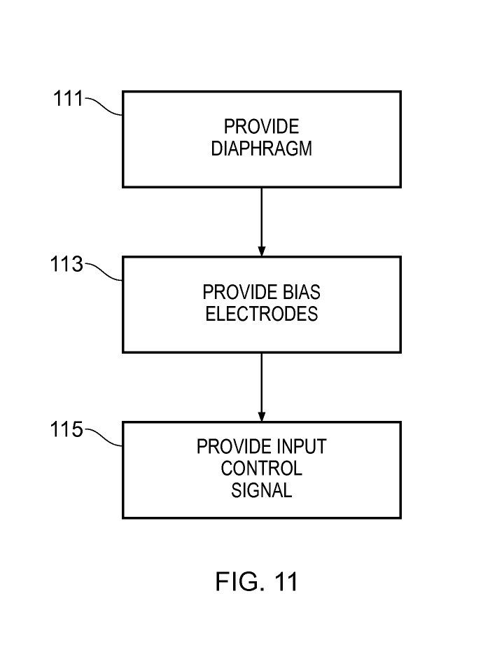

FIG. 11 illustrates an example method.

### DETAILED DESCRIPTION

The Figures illustrate an apparatus 1 comprising: a diaphragm 3 wherein the diaphragm 3 is configured into a corrugated arrangement comprising a plurality of folds; a plurality of bias electrodes 5 where the bias electrodes 5 are provided between folds of the diaphragm 3; and an input configured to provide at least one control signal to the diaphragm 3 to cause movement of the diaphragm 3 to generate an acoustic signal; wherein the diaphragm 3 is configured such that bending stiffness of the diaphragm 3 provides a restoring force to the diaphragm 3 which causes the diaphragm 3 to return to a neutral position when no control signal is applied.

As the bending stiffness of the diaphragm 3 causes the diaphragm 3 to return to a neutral position there is no need to apply any external tensile forces to the diaphragm 3. This enables a larger surface area of the diaphragm 3 to move which may provide a more efficient audio transducer such as an electrostatic loudspeaker.

FIG. 1 illustrates an example apparatus 1. The example apparatus 1 comprises a diaphragm 3 and a plurality of bias electrodes 5. The example apparatus 1 may be configured to covert an electric input signal to an audio output signal. The example apparatus 1 may provide an electrostatic loudspeaker.

The diaphragm may comprise any means which may be configured to move to create an acoustic signal. The acoustic signal may be any audio output signal. The acoustic signal may be heard by a user. The diaphragm 3 may comprise a thin, flexible membrane. The diaphragm 3 may comprise a material which may have a low bending stiffness. The bending stiffness of the diaphragm 3 may enable portions of the diaphragm 3 to bend when a control signal is applied to the diaphragm 3. The bending stiffness of the diaphragm 3 may provide a restoring force to the diaphragm which causes the diaphragm 3 to return to a neutral position when no control signal is applied. The diaphragm 3 may comprise an electrically conductive material. For example the diaphragm 3 may comprise a thin metal foil, conductively coated plastic sheets, graphene films or any other suitable material.

In the example apparatus 1 of FIG. 1 the diaphragm 3 has a length which extends in an x direction and a width which extends in the z direction, as indicated by the axis. The diaphragm 3 is folded into a corrugated arrangement. The folds of the corrugated arrangement give the diaphragm 3 a height which extends in the y direction.

The corrugated arrangement comprises a plurality of alternating folded portions 11 and flat portions 17. The folded portions 11 provide a series of alternating peaks 13 and troughs 15. The folded portions 11 bend through 180° so that, in a neutral configuration, the flat portions 17 are parallel or substantially parallel to each other. In the example apparatus 1 of FIG. 1 the folded portions 11 are curved. The curvature of the folded portions 11 creates a space between consecutive flat portions 17 of the diaphragm 3.

The diaphragm 3 may be arranged so that when a control signal is provided to the diaphragm 3 the flat portions 17 can bend towards, or away from, the bias electrodes 5. The diaphragm 3 may be arranged so that when a control signal is provided to the diaphragm 3 the folded portions 11 do not move. In some examples the folded portions 11 may be fixed in position. In some examples the peaks 11 and troughs 15 of the folded portions 11 may be fixed in position to restrict movement of the folded portions 11.

In the example of FIG. 1 the diaphragm 3 is illustrated in a neutral position in which no control signal is provided to the diaphragm 3. When no control signal is provided to the diaphragm 3 the diaphragm 3 may remain in the neutral position so no acoustic signal is generated. The control signal may be provided from a processor or other controlling circuitry.

When the diaphragm 3 is in the neutral position no tension is provided to the diaphragm 3 from an external source. When the diaphragm 3 is in the neutral position the flat portions 17 of the diaphragm 3 are parallel or substantially parallel to each other.

In the example of FIG. 1 the diaphragm 3 has a constant thickness so that each point of the diaphragm 3 has the same thickness. In some examples the diaphragm 3 may be configured so that the diaphragm 3 has different thicknesses at different points. For example, the diaphragm 3 may be thicker at the folded portions 11 and thinner at the flat portions 17. This may reduce the mass of the moving portion of the diaphragm 3 and provide a more efficient loudspeaker.

The apparatus 1 also comprises a plurality of bias electrodes 5. The bias electrodes 5 may comprise any means which may be configured to generate an electric field which enables movement of the diaphragm 3.

The bias electrodes 5 may be arranged so that the electric field provided by the bias electrodes 5 is large in the regions where the flat portions 17 of the diaphragm 3 are located. The bias electrodes 5 may be arranged so that the electric field provided by the bias electrodes 5 is small in regions where the folded portions 11 of the diaphragm 3 are located.

In the example of FIG. 1 the plurality of bias electrodes 5 are provided between the folds of the diaphragm 3. In the example of FIG. 1 the bias electrodes 5 are provided in the spaces between the flat portions 17 of the diaphragm 3. In the example of FIG. 1 at least one bias electrode 5 is provided between every fold of the diaphragm 3.

In FIG. 1 each bias electrode 5 comprises a wire with a circular or substantially circular cross section. The wire extends in the z direction. In FIG. 1 each of the bias electrodes 5 is provided at the same height in the y direction. In the particular example of FIG. 1 the bias electrodes 5 are provided at a height which is approximately at a midpoint between adjacent peaks 13 and troughs 15 of the diaphragm 3. It is to be appreciated that other arrangements of the bias electrodes may be used in other examples of the disclosure.

The bias electrodes 5 may be provided alternately at positive and negative potentials.

In some examples the bias electrodes 5 may be coated with an electrically insulating layer. The electrically insulating layer may comprise any means which may be configured to prevent a short circuit if the diaphragm 3 comes into contact with the bias electrodes 5. In some examples the electrically insulating layer may also provide structural damping against mechanical resonance. The insulating layer may comprise, for example, a dielectric material.

The apparatus 1 may also comprise at least one input which may be configured to enable a control signal to be provided to the diaphragm 3. When a control signal is provided to the diaphragm 3 this causes a voltage to be applied to the diaphragm 3. The electric field provided by the bias electrodes 5 causes portions of the diaphragm 3 to bend towards or away from the bias electrodes 5. The folded portions 11 of the diaphragm 3 may be fixed in position so the flat portions 17 may be the only portions of the diaphragm 3 which bend when the control signal is applied. When the control signal is removed the bending stiffness of the diaphragm 3 causes the flat portions 17 to move back to their neutral configuration. This movement of the diaphragm 3 enables an electrical input signal to be converted to an audio output signal.

FIG. 2 illustrates another example apparatus 1. The example apparatus 1 of FIG. 2 comprises a diaphragm 3, a plurality of bias electrodes 5 and a support structure 21. The diaphragm 5 and the bias electrodes 5 may be as described in relation to FIG. 1. Corresponding reference numerals have been used for corresponding features.

The support structure 21 may comprise any means for supporting the diaphragm 3. The support structure 21 may be configured so that it does not move when the diaphragm 3 bends in response to a control signal. The support structure 21 may be configured to prevent movement of the folded portions 11 in the x direction.

The support structure 21 may be acoustically transparent so that the audio signals generated by the apparatus 1 can pass through the support structure 21. In the example of FIG. 2 the support structure 21 comprises a plurality of rigid members. The rigid members are spaced apart from each other to enable an acoustic signal to pass though the support structure 21.

At least part of the diaphragm 3 may be coupled to the support structure 21. In some examples the peaks 13 and troughs 15 of the diaphragm 3 may be fixed to the support structure 21. The peaks 13 and troughs 15 of the diaphragm 3 may be fixed to the support structure 21 using any suitable means such as a conductive adhesive or any other suitable material.

In the example of FIG. 2 the support structure 21 also provides an input configured to provide at least one control signal to the diaphragm 3. In such examples the support structure 21 may be galvanically connected to the diaphragm 3. The support structure 21 may be connected to the diaphragm to provide a direct current path between the support structure 21 and the diaphragm 3.

In some examples more than one control signal may be provided to the diaphragm 3. In such examples different control signals may be provided to different parts of the diaphragm 3. The support structure 21 may be configured to provide the different control signals.

In some examples the bias electrodes 5 may also be supported by the same support structure 21 which supports the diaphragm. In such examples, if the support structure 21 also provides the input for the control signal, the bias electrodes 5 must be electrically isolated from the support structure 21.

The apparatus 1 of FIGS. 1 and 2 may be provided within a device such as an electronic device. The device may be a portable electronic device. The electronic device may be a handheld electronic device which can be carried in a user's hand or bag. The electronic device may be a hand held device such that it is sized and shaped so that the user can hold the electronic device in their hand while they are using the electronic device. The electronic device could be a device such as a mobile cellular telephone, a tablet computer, a personal computer, a personal music player, a television, a non-cellular device or any other suitable electronic device which may comprise a loudspeaker.

FIG. 3 schematically illustrates a cross section of an apparatus 1 as described above in relation to FIGS. 1 and 2. The diaphragm 3, bias electrodes 5 and support structure 21, may be as described above in relation to FIGS. 1 and 2. Corresponding reference numerals have been used for corresponding features.

In FIG. 3 the bias electrodes 5 are provided alternately at positive and negative potentials. The input signal 31 provided to the diaphragm 3 may be variable so that the diaphragm 3 may have a positive or a negative potential.

The movement of the diaphragm 3 when the input signal 31 is applied is indicated by the dashed lines 33 and 39 and the arrows 35 and 37. When a negative voltage is applied to the diaphragm 3 the flat portions 17 of the diaphragm 3 move towards the positive bias electrodes 5 as indicated by the dashed line 33 and the arrow 35. When a positive voltage is applied to the diaphragm 3 the flat portions 17 of the diaphragm 3 move towards the negative bias electrodes 5 as indicated by the dashed line 39 and the arrow 37. When no voltage is applied to the diaphragm 3 the bending stiffness of the diaphragm 3 provides a restoring force which causes the diaphragm 3 to return to the neutral position.

As the folded portions 11 of the diaphragm 3 are fixed to the support structure 21 these do not move. It can be seen from the dashed lines 33 and 39 in FIG. 3 that although the flat portions 17 of the diaphragm 3 may move in the x direction, at least part of the folded portions 11 do not move. In the particular example of FIG. 3 there is no movement of the peaks 13 and troughs 15 of the folded portion 11.

FIG. 4 illustrates a plot of electric field strength in an apparatus 1 such as the example apparatus 1 of FIGS. 1 to 3. In this example apparatus 1 the total height of the apparatus 1 is 4 mm and the spacing between consecutive bias electrodes 5 is 2 mm. The bias applied to the bias electrodes 5 is +/−10V. In the example of FIG. 4 a thin copper sheet was used for the diaphragm 3.

It can be seen that the electric field strength is high in the regions around the bias electrodes 5 and the flat portions 17 of the diaphragm 3. However the electric field strength is low in the regions around the folded portions 11 of the diaphragm 3 which are fixed in position.

FIG. 5 illustrates a plot indicating the direction of the electric field using the same example apparatus as for FIG. 4. The arrows around the bias electrodes 5 and the diaphragm 3 indicate the direction of the electric field and the direction in which the diaphragm 3 would move.

FIG. 6 illustrates an example electric circuit for an apparatus 1. In the schematic example of FIG. 6 the diaphragm 3 is illustrated as a flat sheet however it is to be appreciated that the diaphragm 3 would be arranged in a corrugated arrangement. Also in the schematic example of FIG. 6 the bias electrodes 5 are represented as a grid for the purpose of clarity.

In FIG. 6 an input control signal 31 is provided to the diaphragm 3. The input control signal 31 may be provided from an audio amplifier 63. In the example of FIG. 6 the audio amplifier 63 provides the control signal via a transformer 61. Bias control signals may also be provided to each of the bias electrodes 5.

FIG. 7 illustrates an example electric circuit for an apparatus 1. As in the schematic example of FIG. 6 the diaphragm 3 is illustrated as a flat sheet however it is to be appreciated that the diaphragm 3 would be arranged in a corrugated arrangement. Also in the schematic example of FIG. 7 the bias electrodes 5 are represented as a grid for the purpose of clarity.

In FIG. 7 the input control signal 31 is provided directly to the diaphragm 3. The input control signal 31 may be provided from an audio amplifier 63. Bias control signals may also be provided to each of the bias electrodes 5.

FIGS. 8A to 8C illustrate cross sections through example apparatus 1. The examples of FIGS. 8A to 8C illustrate different example arrangements of the bias electrodes 5. It is to be appreciated that other arrangements could be used in other examples of the disclosure.

In FIG. 8A the apparatus 1 comprises one bias electrode 5 provided between each of the folds of diaphragm 3. The bias electrodes 5 have a circular cross section. The bias electrodes 5 may comprise a wire which extends along the width of the diaphragm 3.

The shading of the bias electrodes 5 indicates the polarity of the bias electrodes 5. The shaded electrodes 5 may have a positive charge and the non-shaded electrodes 5 may have a negative charge. It can be seen that consecutive electrodes 5 have opposite charges.

The arrangement of FIG. 8A provides a simple arrangement but may still provide sufficient electric field strength to enable movement of the diaphragm 3.

In FIG. 8B illustrates a second arrangement for the bias electrodes 5. In the arrangement of FIG. 8B three bias electrodes are provided between each of the folds of the diaphragm 3. In the example of FIG. 8B each of the bias electrodes 5 have a circular cross section and comprise a wire which extends along the width of the diaphragm 3. It is to be appreciated that other shapes of electrodes may be used in other examples. In the example of FIG. 8B all of the bias electrodes 5 have the same size and shape. It is to be appreciated that in other examples different bias electrodes 5 may have different sizes and shapes.

In the example of FIG. 8B the three electrodes 5 provided between each fold of the diaphragm 3 are arranged stacked on top of each other. It is to be appreciated that other arrangements may be used in other examples of the disclosure.

In the example of FIG. 8B each of the electrodes 5 provided between one fold have the same polarity. Between a first fold of the diaphragm 3 there is provided three positively charged bias electrodes 5 and between the next fold of the diaphragm 3 there is provided three negatively charged bias electrodes 5.

The example arrangement of FIG. 8B may provide a more homogenous field distribution compared to the arrangement of FIG. 8A. The arrangement of FIG. 8B may also use deeper folds than the arrangement of FIG. 8A. This may provide an increased acoustic output for the same frontal area of diaphragm 3. The frontal area of the diaphragm 3 may be the area in the x-z plane (as indicated by the axis in FIG. 1).

In FIG. 8C the apparatus 1 comprises one bias electrode 5 provided between each of the folds of diaphragm 3. In FIG. 8C the bias electrodes 5 have an elongated rectangular cross section. The elongated rectangle may have a length which extends in the same direction as the height of the diaphragm 3.

The shading of the bias electrodes 5 indicates the polarity of the bias electrodes 5. The shaded electrodes 5 may have a positive charge and the non-shaded electrodes 5 may have a negative charge. It can be seen that consecutive electrodes 5 have opposite charges.

The example arrangement of FIG. 8C may provide a simple structure but still may provide a more homogenous field distribution compared to the arrangement of FIG. 8A. The arrangement of FIG. 8C may also use deeper folds than the arrangement of FIG. 8A. This may provide an increased acoustic output for the same frontal area of diaphragm 3.

FIG. 9 illustrates an example displacement of a diaphragm 3 in an example apparatus 1. A portion of a cross section of the diaphragm 3 is illustrated in the plot of FIG. 9.

In the example of FIG. 9 an aluminum diaphragm 3 with a constant thickness of 0.2 mm was used. The height of the diaphragm 3 was 4.2 mm and the width of diaphragm 3 from peak 13 to trough 15 was 2 mm.

The non-shaded portion in FIG. 9 shows the diaphragm 3 in a neutral configuration. The shaded portions shows the diaphragm 3 when it is subjected to a homogenous horizontal force.

FIG. 10 is a plot of air velocity for the same example apparatus 1 as used in FIG. 9. It can be seen that the movement of the diaphragm enables an acoustic signal to be provided.

FIG. 11 illustrates an example method. The method comprises providing, at block 111, a diaphragm 3 wherein the diaphragm 3 is configured into a corrugated arrangement comprising a plurality of folds. The method comprises, at block 113, providing a plurality of bias electrodes where the bias electrodes are provided between folds of the diaphragm 3. The method also comprises providing, at block 115, an input configured to provide at least one control signal to the diaphragm 3 to cause movement of the diaphragm 3 to generate an acoustic signal to be provided. The diaphragm 3 may be configured such that bending stiffness of the diaphragm 3 provides a restoring force to the diaphragm 3 which causes the diaphragm 3 to return to a neutral position when no control signal is applied.

The blocks illustrated in the FIG. 11 may represent steps in a method. The illustration of a particular order to the blocks does not necessarily imply that there is a required or preferred order for the blocks and the order and arrangement of the blocks may be varied. Furthermore, it may be possible for some blocks to be omitted.

The example apparatus 1 described in this description may provide an electrostatic loudspeaker which may be suitable for use in a compact device.

As the inherent bending stiffness of the diaphragm 3, rather than any applied tension, provides the restoring force for returning the diaphragm 3 to a neutral configuration, this may allow for a larger surface area of the diaphragm 3 to move. This may provide a more effective loudspeaker.

The apparatus 1 may be used to provide a loudspeaker having a curved surface. As the diaphragm 3 is folded into corrugated arrangement it can be arranged to provide a cylindrically curved surface. In such arrangements, rather than extending in the x direction (as illustrated in FIG. 1) the diaphragm 3 could be curved around the z axis (as illustrated in FIG. 1).

The curved surface arrangement may provide an improved audio output signal pattern. The audio output signal pattern may be particularly improved for high frequencies. At high frequencies the shape of the audio output signal pattern may be governed by the shape of the loudspeaker and so arranging the diaphragm 3 in a curved configuration may improve the signal pattern.

In this description the term coupled means operationally coupled. It is to be understood that any number or combination of intervening elements can exist between coupled components including no intervening elements.

Where a structural feature has been described, it may be replaced by means for performing one or more of the functions of the structural feature whether that function or those functions are explicitly or implicitly described.

The term “comprise” is used in this document with an inclusive not an exclusive meaning. That is any reference to X comprising Y indicates that X may comprise only one Y or may comprise more than one Y. If it is intended to use “comprise” with an exclusive meaning then it will be made clear in the context by referring to “comprising only one . . . ” or by using “consisting”.

In this brief description, reference has been made to various examples. The description of features or functions in relation to an example indicates that those features or functions are present in that example. The use of the term “example” or “for example” or “may” in the text denotes, whether explicitly stated or not, that such features or functions are present in at least the described example, whether described as an example or not, and that they can be, but are not necessarily, present in some of or all other examples. Thus “example”, “for example” or “may” refers to a particular instance in a class of examples. A property of the instance can be a property of only that instance or a property of the class or a property of a sub-class of the class that includes some but not all of the instances in the class. It is therefore implicitly disclosed that a features described with reference to one example but not with reference to another example, can where possible be used in that other example but does not necessarily have to be used in that other example.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, t

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising:
a diaphragm comprising a length, a width and a height wherein the diaphragm is configured into a corrugated arrangement comprising a plurality of folds being extended along the length and said plurality of folds give the diaphragm the height;
a plurality of bias electrodes which extend along the width of the diaphragm where the bias electrodes are provided between folds of the diaphragm; and
an input configured to provide at least one control signal to the diaphragm to cause movement of the diaphragm to generate an acoustic signal; wherein
the diaphragm is configured such that bending stiffness of the diaphragm provides a restoring force to the diaphragm which causes the diaphragm to return to a neutral position when no control signal is applied.

2. The apparatus as claimed in claim 1, wherein at least one bias electrode is provided between every fold.

3. The apparatus as claimed in claim 1, wherein the bias electrodes are provided alternately at positive and negative potentials.

4. The apparatus as claimed in claim 1, wherein folded portions of the diaphragm are fixed in position.

5. The apparatus as claimed in claim 1, wherein the bias electrodes provide an electric field and are arranged so that the electric field is small at the folded portions of the diaphragm.

6. The apparatus as claimed in claim 1, wherein no external tensile forces are applied to the diaphragm to return the diaphragm to a neutral position.

7. The apparatus as claimed in claim 1, comprising a support structure configured to support the diaphragm, wherein the support structure is configured to provide the control signal to the diaphragm.

8. The apparatus as claimed in claim 1, wherein the diaphragm has different thicknesses at different points.

9. The apparatus as claimed in claim 1, wherein the diaphragm is arranged in a curved configuration.

10. The apparatus as claimed in claim 1, wherein the bias electrodes comprises one of:
a substantially circular cross section; and
an elongated rectangular cross section.

11. The apparatus as claimed in claim 1, wherein the plurality of folds provide a series of peaks and troughs in such a way that the plurality of bias electrodes are positioned at a height approximately at a midpoint between adjacent peaks and troughs.

12. A method comprising:
providing a diaphragm having a length, a width and a height wherein the diaphragm is configured into a corrugated arrangement comprising a plurality of folds being extended along the length and said plurality of folds give the diaphragm the height;
providing a plurality of bias electrodes which extend along the width of the diaphragm where the bias electrodes are provided between folds of the diaphragm; and
providing an input configured to provide at least one control signal to the diaphragm to cause movement of the diaphragm to generate an acoustic signal; wherein
the diaphragm is configured such that bending stiffness of the diaphragm provides a restoring force to the diaphragm which causes the diaphragm to return to a neutral position when no control signal is applied.

13. The method as claimed in claim 12, comprising providing at least one bias electrode between every fold.

14. The method as claimed in claim 12, comprising providing the bias electrodes alternately at positive and negative potentials.

15. The method as claimed in claim 12, comprising fixing folded portions of the diaphragm in position.

16. The method as claimed in claim 12, wherein the bias electrodes provide an electric field and are arranged so that the electric field is small at the folded portions of the diaphragm.

17. The method as claimed in claim 12, wherein no external tensile forces are applied to the diaphragm to return the diaphragm to a neutral position.

18. The method as claimed in claim 12, further comprising providing a support structure configured to support the diaphragm and wherein the support structure is providing the control signal to the diaphragm.

19. The method as claimed in claim 12, wherein the diaphragm has different thicknesses at different points.

20. The method as claimed in claim 12, wherein the diaphragm is arranged in a curved configuration.
